(19) United States
(12) Patent Application Publication
(10) Pub. No.: US 2008/0195496 A1
(43) Pub. Date: Aug. 14, 2008

(54) METHOD AND SYSTEM FOR PROVIDING POINT OF SALE DETAILS TO A USER

(76) Inventor: Helen Y. Hwang, Roswell, GA (US)

Correspondence Address: RUSSELL W. BURGE, 21140 COVINA HILLS ROAD, COVINA, CA, 91724, US

(21) Appl. No.: 11/672,956

(22) Filed: Feb. 8, 2007

(51) Int. Cl. G06Q 20/00

(52) U.S. Cl. 705/17; 705/16

(57) ABSTRACT

At a point-of-sale, a retail customer can elect to have transaction details uploaded to a server, or to have the details stored on removable media, for later loading into budget or financial software by the customer. The election and selection of a destination for uploading the transaction details can be through a card, touch-screen entry, or by the cashier. The different detail items in the transaction are automatically categorized through customizable templates for the customer.

### FIELD OF THE INVENTION

The present invention generally relates to computer based budgeting and, more specifically, to automatically providing point of sale detail information for use in budgeting and financial software.

### BACKGROUND OF THE INVENTION

Currently, many banks and credit card companies provide for the ability to download credit card, debit card, and check transactions to a user system for use in financial software such as Quicken and Microsoft Money. The transaction total is provided, often along with some identification of the payee or a check number. This is useful in balancing a user's checkbook and credit card account.

One problem though is that a transaction total, such as how much was spent at a given store, is often not overly useful when doing in-depth budgeting and preparing tax returns. This is because in many cases, a single transaction may include the purchase of items for different purposes. For example, business and personal expenses may be intermingled. Or, even in a case of personal expenses, some expenses in one transaction may be for food while others for household maintenance. Currently, the only real options are to use multiple transactions for different categories, or to retain paper receipts of each transaction, and then manually input transaction details into budget or financial software.

It would therefore be advantageous to provide consumers and businesses transaction details and also advantageous to provide a mechanism for automatically classifying the transaction details into categories.

### BRIEF SUMMARY OF THE INVENTION

At a point-of-sale, a retail customer can elect to have transaction details uploaded to a server, or to have the details stored on removable media, for later loading into budget or financial software by the customer. The election and selection of a destination for uploading the transaction details can be through a card, touch-screen entry, or by the cashier. The different detail items in the transaction are automatically categorized through customizable templates for the customer.

### BRIEF DESCRIPTION OF THE DRAWINGS

FIG. 1 is a diagram illustrating consumer transactions, in accordance with the prior art;

FIG. 2 is a diagram illustrating consumer transactions, in accordance with the present invention;

FIG. 3 is a block diagram illustrating the logical layout of the present invention, in accordance with the present invention;

FIG. 4 is a block diagram providing another view of the present invention; and

FIG. 5 is a block diagram illustrating a General Purpose Computer.

### DETAILED DESCRIPTION OF THE INVENTION

The present invention provide for an Automated DETAILED Expense Tracking Process: at every point-of-sale (using any payment method, either bank card, credit card, cash, or checks), all the transaction details will preferably automatically be sent to a remotely located budget server, where the list of items (initially categorized) will be automatically updated to expense, budget, and bank reconciliation templates. The transfer would include the list of every item purchased at a location such as a store, rather than the total amount spent, which would give more itemized list for better budgeting purposes. When transactions occur, the consumer's budget template will be updated automatically at the point of sale and the detailed information will be transmitted directly out to a designated server where the software is located. No more waiting for the bank to clear certain items, or the outstanding checks to be typed in manually into the budget software will be necessary. (Detailed transaction data collecting process either by a specific electronic device or a remote server that can be retrieved and stored for later usage)

One objective of the present invention is to update the budget software automatically when transactions occur instead of waiting to download from another source (i.e. internet banking). At the point of sale, the transaction detail will preferably be automatically sent to a remotely located budget server and update budget templates when money is spent at any commercial retail stores without a single key stroke. This may be done through the point-of-sale computers. The consumers will typically be assigned with one unique customer identification code where they can use it at any locations where the cash registers are available. The point-of-sale computer will preferably be set up to read the customer ID code and built so that when the ID code is input or scanned, automatic transfer of the data to a server takes place. Currently, consumers obtain and download their account transactions into the budget software from online services, which is provided by either bank or credit card companies. This process is not ideal for any cash or check payments, because they are simply not characterized as bank or credit card transactions. These non-bank or credit card transactions have to be entered by the consumers manually in order to keep track of the expenses. The new process will not depend on the payment method, for the cash register will only require the customer identification code to send the information to. (Note: The very initial stage of setting up the budget template according to the end user's preferences, including various items to categorize, will need to be done at the beginning of the process. Once this is complete, the end user would still have the option to edit and update at any future time).

Another objective is to offer Paperless Receipts. Paper receipts are very easy to get misplaced or lost. One way paperless receipts can be retrieved electronically is to build a device that consumers can carry around and at the point of sale, the device can be used to download transaction details (receipt) into it. Consumers can then retrieve and store this information on their home computer or any other electronic devices, such as palm pilots, cell phones, lap-tops, and other portable gadgets. This can help immensely during tax season, where people don't have to spend as much time finding the “old” receipts and having to them filed by the tax consultants.

Another objective is to break out every detail item of purchased products to create tighter budget categories. Currently, consumers can obtain the details of transactions either by keeping the actual paper receipts or calling the vendors directly. The bank and credit card statements (either online or paper), currently only show the total amount spent at a particular location and a particular date, and not the detail of what was spent on what. Online banking has become very popular and user-friendly. Even most major credit card statements can be viewed online. Most of the online financial services currently available have accessibility allowing for consumers to download their transaction details into existing budget software such as Microsoft Money or Quickens, if that detail were available. However, the ability for a consumer to see every detail of the items purchased is currently not available. For example, assume that a consumer spends certain amount of money at Wal-Mart. In order for the consumer to break out how much is spent on toilette papers, baby diapers, dog foods, hair products, and food items, she would need to refer back the paper receipt that was given to her at the store. This is currently true because only the TOTAL amount spent is showing on the consumer's online or offline statements, and NOT the itemized list.

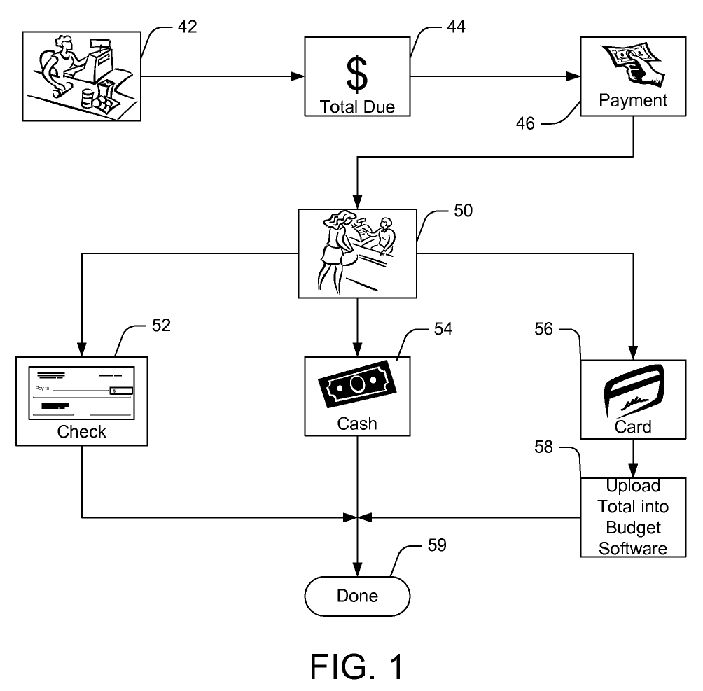

FIG. 1 is a diagram illustrating consumer transactions, in accordance with the prior art. A clerk rings up the individual items 42, and a total amount due is provided the customer/consumer 44. The customer provides payment 46 with a clerk 50 either through a check 52, cash 54, or credit or debit card 56. If the consumer purchased the items via a card 56, he can then download the transaction total to budget software 58, such as Quicken or Microsoft Money. The transaction total and sometimes the payee may also be available online if the consumer paid by check 52, but he will have to manually enter the transaction total if he paid with cash 54. In any case, the transaction is now complete 59.

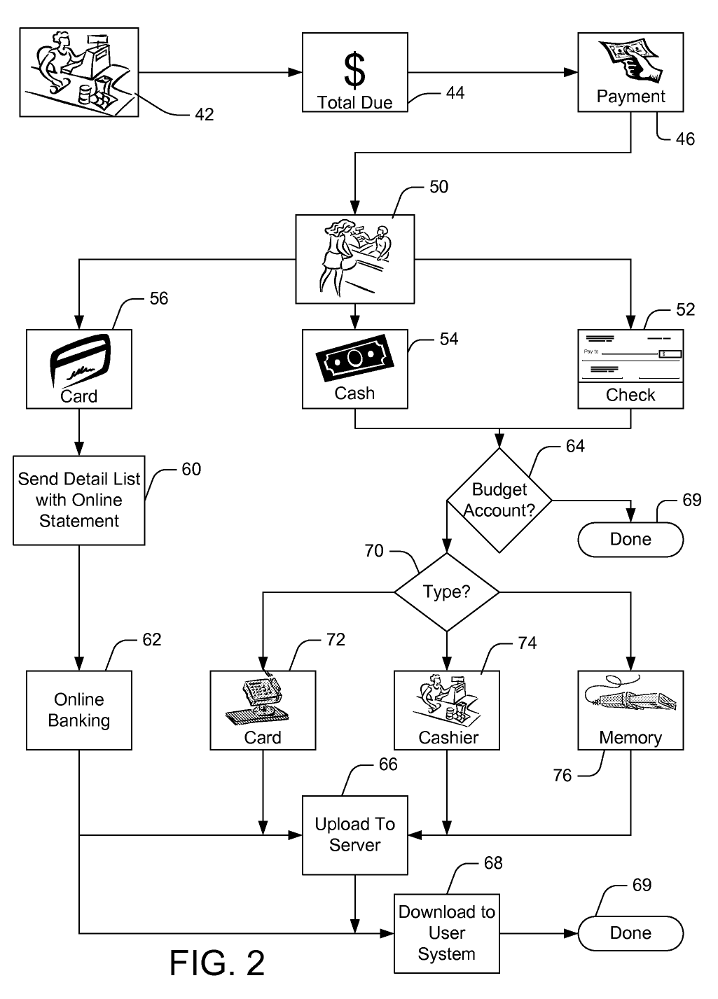

FIG. 2 is a diagram illustrating consumer transactions, in accordance with the present invention. As with FIG. 1, A clerk rings up the individual items 42, and a total amount due is provided the customer/consumer 44. The customer provides payment 46 with a clerk 50 either through a check 52, cash 54, or credit or debit card 56.

However, the present invention provides for further capabilities. In the case of a credit card payment 56, the transaction details can be sent 60 to the provider of the card 60, and made available through online banking 62, and later uploaded to a server 66 or downloaded directly to the consumer's system 68 for use in budgeting software. In the case of payment by check 52 or cash 54, and alternatively by card 56, the consumer is given an opportunity to specify that transaction details are to be retained 64. If not, then the transaction is complete 69, as it was in FIG. 1. Otherwise, the consumer is given a choice of what type of mechanism he wishes to utilize to retain the transaction details 70. He may indicate his choice through swiping a card 72 or having the cashier identify it 74 via the consumer's telephone number or PIN. In some stores this can be incorporated into identification of the customer through a customer loyalty card such as those that are currently used in most supermarkets. The customer may alternatively download the transaction details to a memory device 76 such as EEPROM, that are currently becoming ubiquitous. In any case, the transaction details can then be uploaded to a server 66, for later download to the customer's system 68. The transaction is then complete 69.

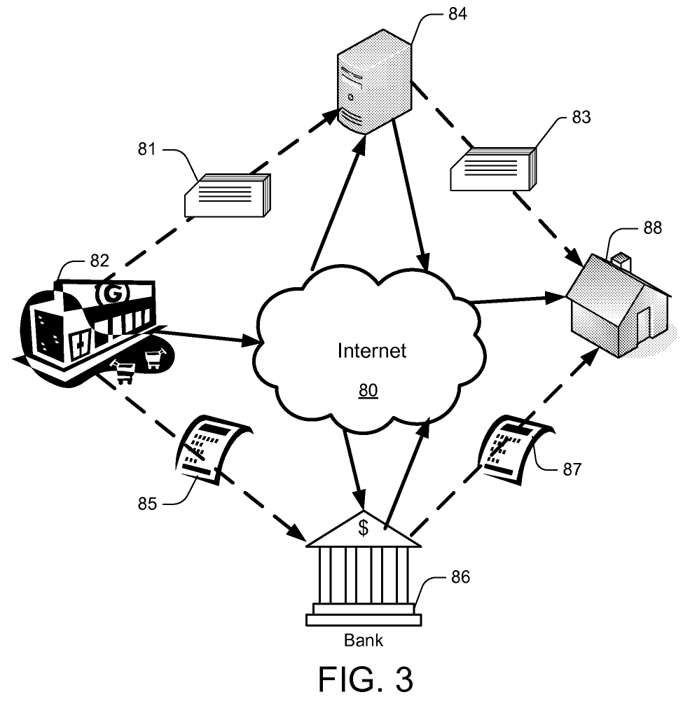

FIG. 3 is a block diagram illustrating the logical layout of the present invention, in accordance with the present invention. A store 82 transmits transaction details 81 to a server 84 and account thereof identified by the customer. The actual payment information is typically transmitted 85 to the payment system 86. It should be understood that this typically results in payment information being first sent to a clearing house, and then later to the consumer's bank or credit card company. This is within the prior art, with billions of payments a day being processed in this manner. The user can then download the transaction details 83 to his own system 88 for use in budgeting software, and can download the actual payments 87 to his own system 88 for use in accounting software. The various transmittals 81, 83, 85, 87, are shown occurring across the Internet. This is for simplicity, since some may travel via other means, such as by direct or dial-up links.

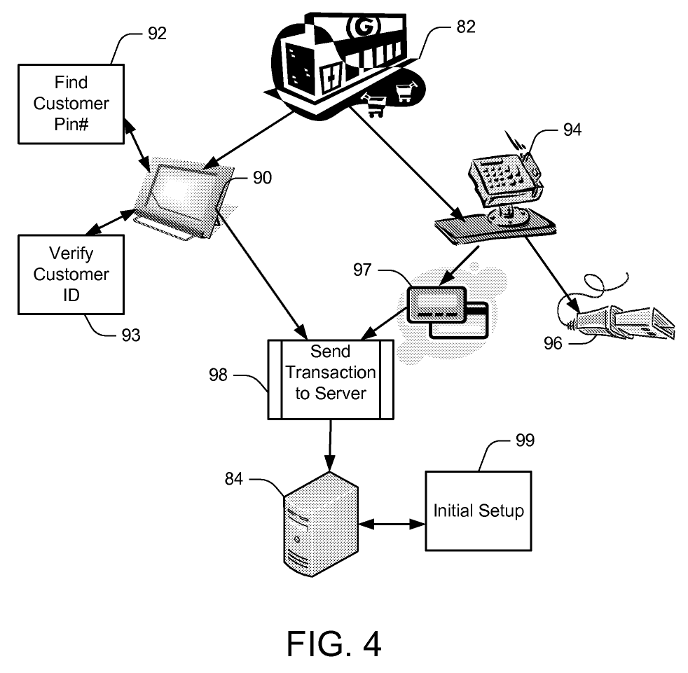

FIG. 4 is a block diagram providing another view of the present invention. At a retail store 82, a customer is given several choices as to how and where to transmit transaction details. He may enter his customer number or ID 92 on a touch screen 90 which can be verified 94, for example, through entry of a PIN. Alternatively, a clerk at the store may input some or all of this information (see FIG. 2). Or, the customer may swipe a card 94 to identify himself and where to send his transaction detail information. In any case, the transaction detail information 97 can transmitted 98 to a designated account on a designated server 84 and/or stored on a personal memory device 96, such as a USB EEPROM device. In either case, the transaction detail information can later be uploaded or downloaded (as appropriate) to the user's system for use in budgeting software.

In one embodiment of the present invention, transaction details are classified and categorized as to type in the server 84 to which they were uploaded 98. Part of the classification and/or categorization would be to separate transaction details into personal and business expenses. Indeed, more than one personal and/or business category may be set up. This all would typically require setup 99, where a user could personalize any portion of the classification and categorization. This would preferably also be changeable on a dynamic basis as his needs change over time.

The next portion of this disclosure describes potential implementations of the categorization and classification of transaction details performed either in a server 84 or in a user's system 88.

Various vendors, such as Publix, Home Depot, Wal-Mart, Target, etc., can transfer the actual detail list of items purchased to any banks and major credit card companies that are available through on-line statements. The on-line bank and credit card statements can be retrieved in details by both debit/credit transactions. The transaction data can be downloaded into budgeting software (such as Quicken and Money) that is commercially available as part of their service to the customers. Currently, on-line statements store every transaction by: date; payee; type of transaction; and the amount spent. These on-line statements currently do not have an option to expand the detail list of items purchased at stores where they sell multiple types of products. Many of these stores include grocery home improvement departments. An example of a current on-line bank/credit card statements shows the following:

| | | C | |
|---|---|---|---|
| A | B | Type Of | D |
| Date | Description | Transaction | Amount |
| May 20, 2006 | Publix | Debit | $50.00 |

This $50 is the total amount spent at the store, but in order to record detailed itemized list of products purchased, the only way to do this is to manually type in the items by looking at the paper receipt itself.

On-line banking can become more user friendly and efficient. They can add a new feature/option where each transactions can be broken down even further than what it currently offers. The on-line bank/credit card statements will be able to show the following with two options to choose from. Option 1 displays the transaction in summarized form:

Summarized format
Detailed format

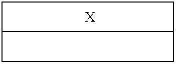

| | | C | D | | | |
|---|---|---|---|---|---|---|
| A | B | Type Of | Detailed | E | F | G |
| Date | Description | Transaction | List | Amount | Subtotal | Option#1 |
| May 20, 2006 | Publix | Debit | | | 50 | Summarized |

This format will be the same as the prior art style where only the total amount spent in each transaction is listed. (This targets consumers who do not care about the itemized list).

Option 2 displays the transaction details in a Detailed Format:

Summarized format
Detailed format

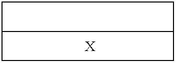

| | | C | D | | | |
|---|---|---|---|---|---|---|
| A | B | Type Of | Detailed | E | F | G |
| Date | Description | Transaction | List | Amount | Subtotal | Option#1 |
| May 20, 2006 | Publix | Debit | Baby diapers | 20 | | |
| May 20, 2006 | Publix | Debit | Milk | 5 | | |
| May 20, 2006 | Publix | Debit | Paper Towels | 7 | | |
| May 20, 2006 | Publix | Debit | Shampoo | 3 | | |
| May 20, 2006 | Publix | Debit | Steaks | 8 | | |
| May 20, 2006 | Publix | Debit | Tooth brush | 3 | | |
| May 20, 2006 | Publix | Debit | Tax | 4 | 50 | Subtotal |

The detail lists are itemized in column E and the subtotal is still shown in column F.

To make the Budget process more efficient, the vendors (retail stores) can create a CATEGORY CODE for each product that they sell. For example, assuming two transactions, one at Wal-Mart, and one at Home Depot:

Store A: Wal-Mart

| Store | Item# | Item | Generic | Category |
|---|---|---|---|---|
| ID | (Bar Code) | Description | Category Code | Description |
| A | 100007 | Baby Diapers | XX3 | Baby supply |
| A | 100008 | Milk | XX7 | Dairy product |
| A | 100887 | Shampoo | XX5 | Beauty supply |

Store B: Home Depot

| | Item# | Item | Generic | Category |
|---|---|---|---|---|
| Store ID | (Bar Code) | Description | Category Code | Description |
| B | 100007 | Paints | XX3 | Paints |
| B | 100008 | Woods | XX7 | Household |
| B | 100887 | Hammer | XX5 | Tools |

The next table illustrates one way to identify and convert the Generic category codes into the Budget software. Preferably, budgeting software available to consumers would be enhanced to add this conversion process:

| | Item# | Item | Generic | Category |
|---|---|---|---|---|
| Store ID | (Bar Code) | Description | Category Code | Description |
| A | | | XX3 | Baby supply |
| A | | | XX7 | Food |
| B | | | XX3 | House |
| | | | | Improvement |
| B | | | XX7 | House |
| | | | | Improvement |

Note that all the retailers could have the same “Generic Category Codes”, but the converting process will preferably match a Store identification code to the category code and determine the end result category.

When the transaction data is transferred out to the server at the Point-of-Sale, the budget software will preferably automatically identify the “store id code” and will categorize them according to how the end user is set up initially.

If end users do not prefer to use the “Generic Category Code[s]”, which are already set up by vendors, then they preferably can have the capability of modifying and creating a new category for that specific product code. When the same product is purchased in the future, the budget software preferably will automatically ignore the generic category code and will assign a newly created category that was set up by the end user.

In case the vendors (i.e. retail stores) have no category codes available for consumers, then the following result preferably may be seen from the software end.

Store B: Business X

| | Item# | Item | Generic | Category |
|---|---|---|---|---|
| Store ID | (Bar Code) | Description | Category Code | Description |
| C | 100007 | Baby Diapers | n/a | |
| C | 100008 | Milk | n/a | |
| C | 100887 | Shampoo | n/a | |

When the transaction from this store is being converted to the Budgeting Software:

| | Item# | Item | Generic | Category |
|---|---|---|---|---|
| Store ID | (Bar Code) | Description | Category Code | Description |
| A | | Baby Diapers | n/a | n/a |
| A | | Milk | n/a | n/a |
| A | | Shampoo | n/a | n/a |

The budget software will typically not be able to categorize these items. These unidentified expenses will then be dumped into a category called, for example, “unknown categories”, or “unidentified items need to be categorized”. The customers typically will then need to assign these items to a particular category, one by one. Once complete, any future purchases at the same stores or chains of the same or similar items will be automatically categorized into the same categories.

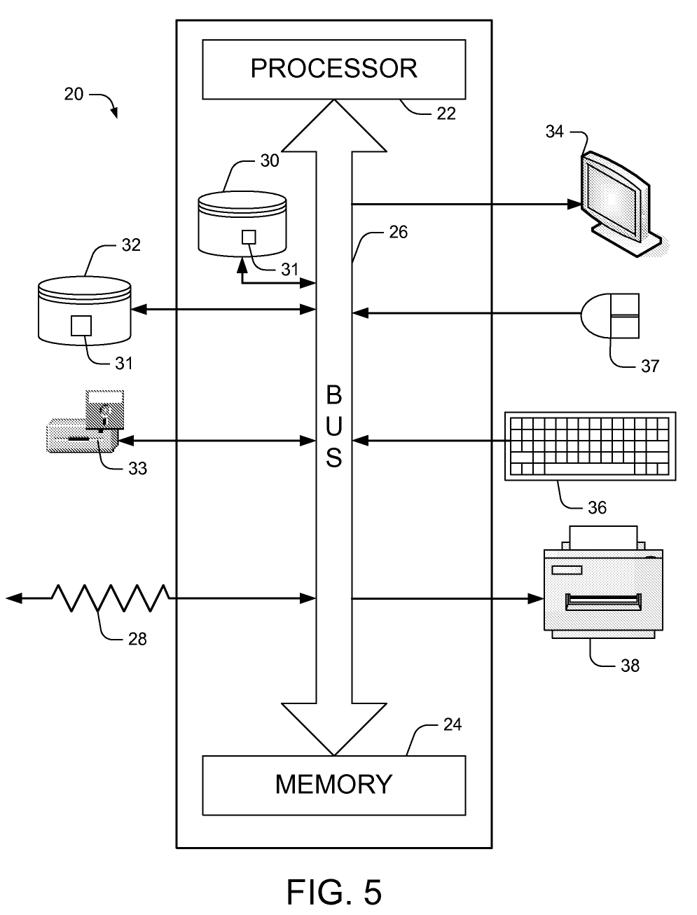

FIG. 5 is a block diagram illustrating a General Purpose Computer 20. The General Purpose Computer 80 has a Computer Processor 22, and Memory 24, connected by a Bus 26. Memory 24 is a relatively high speed machine readable medium and includes Volatile Memories such as DRAM, and SRAM, and Non-Volatile Memories such as, ROM, FLASH, EPROM, EEPROM, and bubble memory. Also connected to the Bus are Secondary Storage 30, External Storage 22, output devices such as a monitor 34, input devices such as a keyboard 36 and mouse 37, and printers 38. Secondary Storage 30 includes machine-readable media such as hard disk drives, magnetic drum, and bubble memory. External Storage 32 includes machine-readable media such as floppy disks 33, removable hard drives, magnetic tape, CD-ROM, and even other computers, possibly connected via a communications line 28. The distinction drawn here between Secondary Storage 30 and External Storage 32 is primarily for convenience in describing the invention. As such, it should be appreciated that there is substantial functional overlap between these elements. Computer software such operating systems, finance, budgeting, and user programs as well as user data can be stored in a Computer Software Storage Medium, such as memory 24, Secondary Storage 30, and External Storage 32. Executable versions of computer software 31, such as browser, operating system, finance, and budgeting software can be read from a Non-Volatile Storage Medium such as External Storage 32, Secondary Storage 30, and Non-Volatile Memory and loaded for execution directly into Volatile Memory, executed directly out of Non-Volatile Memory, or stored on the Secondary Storage 30 prior to loading into Volatile Memory for execution.

Those skilled in the art will recognize that modifications and variations can be made without departing from the spirit of the invention. Therefore, it is intended that this invention encompass all such variations and modifications as fall within the scope of the appended claims.

What is claimed is:

1. A method of providing transaction details of a transaction, comprising:
accepting a choice of providing a set of transaction details to the transaction by a customer; and
providing the set of transaction details to the transaction when that choice is chosen by the customer.

2. The method in claim 1 wherein the providing the set of transaction details comprises:
uploading the set of transaction details to a server.

3. The method in claim 2 which further comprises:
automatically categorizing each of the set of transaction details into a predefined category of expense as a set of categorized transaction details based on a categorization criteria.

4. The method in claim 3 which further comprises:
providing a capability for customizing the categorization criteria.

5. The method in claim 3 which further comprises:
providing a capability for downloading the set of categorized transaction details to a user's system.

6. The method in claim 1 wherein the providing the set of transaction details comprises:
loading the set of transaction details into a portable memory device provided by the consumer.

7. The method in claim 1 wherein:
accepting the choice of providing the set of transaction details to the consumer transaction utilizes a card reader capable of reading a card provided by the customer.

8. The method in claim 1 wherein:
accepting the choice of providing the set of transaction details utilizes a touch screen capable of accepting input from the customer.

9. The method in claim 1 wherein:
accepting the choice of providing the set of transaction details utilizes a keypad capable of identifying the customer.

10. The method in claim 1 wherein:
accepting the choice of providing the set of transaction details comprises:
providing a choice of methods for providing the set of transaction details.

11. A system for providing transaction details of a transaction, comprising:
a means for accepting a choice of providing a set of transaction details to the transaction by a customer; and
a means for providing the set of transaction details to the transaction when that choice is chosen by the customer.

12. The system in claim 11 wherein the means for providing the set of transaction details comprises:
a means for uploading the set of transaction details to a server.

13. The system in claim 12 which further comprises:
a means for automatically categorizing each of the set of transaction details into a predefined category of expense as a set of categorized transaction details based on a categorization criteria.

14. The system in claim 13 which further comprises:
a means for customizing the categorization criteria.

15. The system in claim 13 which further comprises:
a means for downloading the set of categorized transaction details to a user's system.

16. The system in claim 11 wherein the providing the set of transaction details comprises:
a means for loading the set of transaction details into a portable memory device provided by the customer.

17. The system in claim 11 which further comprises:
a means for reading a card for providing the choice of providing the set of transaction details.

18. The system in claim 11 which further comprises:
a touch screen for providing the choice of providing the set of transaction details.

19. The system in claim 11 which further comprises:
a keypad capable of accepting input for identifying the customer.

20. A system for storing and categorizing detailed customer transactions comprising:
a means for accepting a set of transaction details from a transaction by a customer;
a means for automatically categorizing each of the set of transaction details into a predefined category of expense as a set of categorized transaction details based on a categorization criteria;
a means of storing the set of categorized transaction details; and
a means of downloading the set of categorized transaction details.
